(19) United States
(12) Patent Application Publication
(10) Pub. No.: US 2002/0073341 A1
(43) Pub. Date: Jun. 13, 2002

(54) System and method for securing computer information from remote sides

(76) Inventor: Chung-Hui Chen, Taipei (TW)

Correspondence Address: Chun M. Ng, BLAKELY, SOKOLOFF, TAYLOR & ZAFMAN LLP, 12400 Wilshire Boulevard 7th Floor, Los Angeles, CA, 90025, US

(21) Appl. No.: 09/733,464

(22) Filed: Dec. 8, 2000

(51) Int. Cl. H04L 9/32; G06F 11/30

(52) U.S. Cl. 713/202

(57) ABSTRACT

A system and method for securing computer information from remote sides is disclosed. The disclosed system basically encompasses a response message manipulating module, a command transference module, and a command interpretation module. The response message module generates associated messages responsive to commands input from remote computers, or identification accompanied with password, while the command transference module packages the commands into packets, or unpacks received packets to restore the commands for further manipulating. The command interpretation module activates associated modules to perform the operations indicated by the commands after interpreting. In operations, the commands input from the users in remote computers will be transferred from the remote ones to the local one via a communication link. The local computer transfers associated responsive messages according to the commands to notify the users that the operations indicated by the commands will be performed in the local computer.

### BACKGROUND OF THE INVENTION

1. Field of the Invention

The present invention relates to a system and method for securing computer information from remote sides. More particularly, the present invention relates to a system and method for securing computer information that forces the local computer to turn power off, suspend or lock itself according commands input from remote computers so as to prevent unallowable operations from performing.

2. Description of the Prior Art

The advancements of computer hardware/software and communication technologies bring the modem world to transfer a variety of information that keeps increasing everyday. It is more convenient to transfer information through networks that are gradually closely connected or coupled than before. People can thus acquire services by connecting their computers, for example, PCs, workstations, notebooks, or palm PCs, with different information exchange networks such as LANs, WANs, the Internet, or wireless communication networks.

People usually input commands on their own computers to download information. However, if they leave their seats in front of the computers for a long time, some others, especially those unauthenticated people may perform unallowable inquiring, changing, or even deleting information when the computer owners do not turn off or lock their computers. Not only important information may be lost, but also some critical commercial chances may be missed caused by the disaster from information loss. Nowadays, another computers at remote sides can turn on some conventional computers because of the prosperity from electrical engineering. People may thus activate their own computers by using an activating command input from remote computers and transferred via a communication link to theirs. It indicates that people can start to use their computers and unnecessary to perform associated activating procedures again when they arrive at the seats in front of their computers. However, no appropriate conventional approach is disclosed to overcome the disadvantage that computer information may be authenticated accessing, inquiring, or even deleting when the computer owners are absent.

### SUMMARY OF THE INVENTION

The principal object of the invention is the provision of a system and method that enables a local computer to perform turning off, suspending, or locking operations according to the commands from a remote computer.

In the preferred embodiment, a user may input command at a remote computer to control a local computer for securing information purpose. The commands will be approved and received after the user in remote side being authenticated by inputting correct identification (such as login name) accompanied with correct password. The commands are then forwarded to the local computer via a communication link. Response messages according to the commands are then transferred back to the remote computer to notify the user that the local computer is going to perform the commands. If an acknowledgement message is input by the user at remote computer, the local one then perform the operations indicated by the commands.

In the preferred embodiment, a response message manipulation module, a command transference module, and a command interpretation module are included therein. The response message manipulation module is the module that generates the required response messages responsive to the commands from the remote computer, or the authentication result of the identification and password. The command transference module packages the identification, password, and commands into packets for transferring purpose, or unpacking the packets from the communication link to restore the identification, password, and commands. The command interpretation module interprets the commands and call associated modules to perform the operations indicated by the commands.

In the preferred embodiment, those power control modules and locking modules for computers may be employed to secure computer information. For example, the advanced power management (APM) module, or the advanced configuration and power interface specification (ACPI) module that are used to manage power for computers conventionally can be employed in the invention to manipulate the operations arisen by the turning off or suspending commands. The computer BIOS or a security software used for locking purpose may also be employed in the invention to prevent the input devices of the local computer from further receiving commands.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of the preferred embodiment of the invention;

FIG. 2 is a schematic diagram illustrative of the configuration of the software modules in the preferred embodiment;

FIG. 3 is a diagram illustrative of the operating flow of the preferred embodiment;

FIG. 4A is a diagram illustrative of the operations for turning off the local computer from remote computers in the preferred embodiment;

FIG. 4B is a diagram illustrative of the operations for suspending the local computer from a remote computer in the preferred embodiment; and

FIG. 4C is a diagram illustrative of the operations for locking the local computer from a remote computer in the preferred embodiment.

### DESCRIPTION OF THE PREFERRED EMBODIMENT

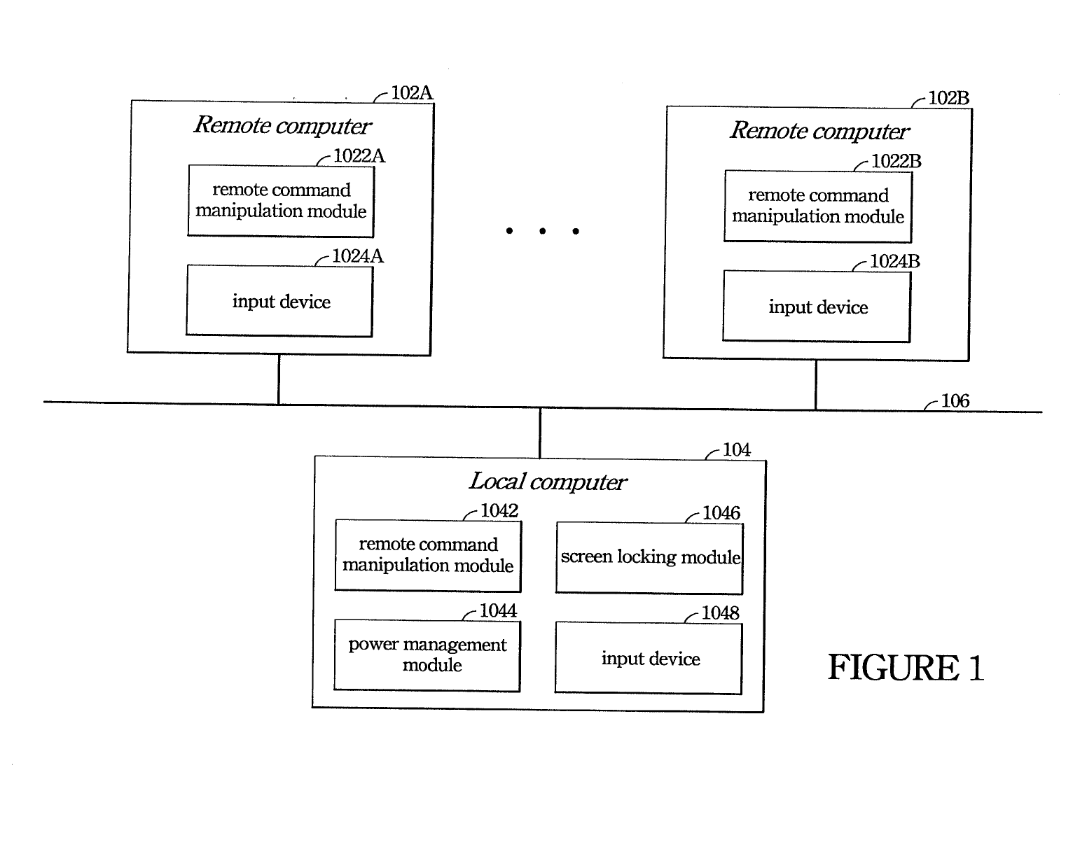

Please refer to FIG. 1, a schematic diagram of the preferred embodiment is shown therein. The schematic diagram in FIG. 1 basically encompasses remote computers 102A and 102B and a local computer 104 that are mutually coupled via a communication link 106. The remote computers 102A and 102B encompasses remote command manipulating modules 1022A and 1022B, input devices 1024A and 1024B, respectively, while the local computer 104 includes a remote command manipulation module 1042, a power management module 1044, a screen protection module 1046, and an input device 1048. The communication link 106 may be a LAN, WAN, the Internet, or a wireless communication network. Additionally, the input device 1024A or 1024B of the remote computer 102A or 102B may be any device, for example, a keyboard, mouse, or cursor control (e.g., track ball), for receiving commands from users. Furthermore, the power management module 1044 of the local computer 104 may be an advanced power management (APM) module or an advanced configuration and power interface specification (ACPI) module used conventionally. The functions of the screen protection module 1046 may be provided from the computer BIOS (Basic Input Output System, BIOS) or a security software that provides quick lock functions, therefore any unauthenticated person can not input command to control the local computer 104. Please note that the aforementioned devices or modules in the embodiment may be changed as various applications but any similar arrangement or modification within the spirit of the invention should be included within the scope of the appended claims.

In operations, when the user at the remote computer 102A or 102B wishes the local computer 104 to perform the suspending, turning off, or locking operation, he/she may input commands through the input device 1022A or 1022B of the remote computer 102A or 102B. This command will be manipulated by the remote command manipulation module 1022A or 1022B to package into a plurality of packets before forwarding to the local computer 104 via the communication link 106. Those packets are unpacked to restore the command in the remote command manipulation module 1042 of the local computer 104 before performing the operation indicated by the command. In the preferred embodiment, the command may activate the power management module 1044 or the screen protection module 1046 to turn off or suspend, or lock the local computer 104, respectively.

Additionally, the persons in the field of the present invention may modify the disclosed structure of the embodiment. For example, the local computer 104 may be selected from “network neighborhood” of the Microsoft Window 95/98 in the remote computer 102A or 102B. User in the remote computer 102A or 102B may input his/her identification and accompanied with password to inquire for control authentication. When the user is authenticated, the local computer 104 transfers response messages to the remote computer 102A or 102B for notifying purpose. Commands input by the user may be input and then forwarded to the local computer 104 via the communication link 106 for further manipulating. Another response message indicated that the command will be performed by the local computer 104 may be optionally transferred to notify the user in the remote computer 102A or 102B. As noted, any computer mounting the remote command manipulation module abovementioned and coupling through the communication link 106 may be the remote computer 102A or 102B, or the local computer 104 under different applications. Furthermore, when the conventional client/server configuration is employed in FIG. 1, the identification and password input by the user may be authenticated in the server before allowing the user to input commands.

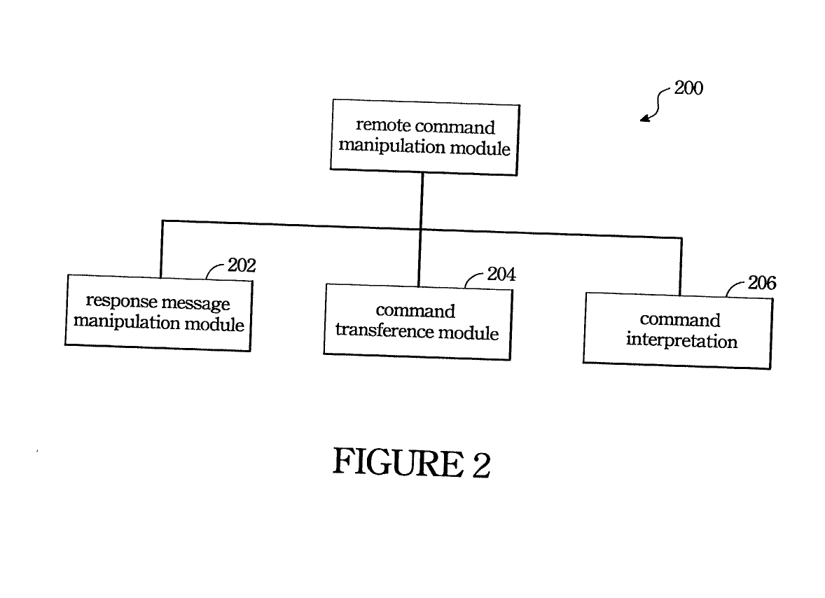

Please next refer to FIG. 2, a schematic diagram illustrative of the module configurations is shown therein. The remote command manipulation module 200 in FIG. 2 basically encompasses a response message manipulation module 202, a command transference module 204, and a command interpretation module 206. The response message manipulation module 202 generates all the required response messages of the embodiment wherein the response messages include the authentication result of the identification and password and the notifications for performing the commands. The command transference module 204 packages the identification, password, or commands into packets before transferring via the communication link 106, or unpacks packets from the communication link 106 to restore the identification, password, or commands for further processing. The command interpretation module 206 interprets the commands input by the user and then calls associated modules (e.g., power management module 1044 or screen protection module 1046) to perform the operations arisen by the commands. It is obvious that any computer mounting the above modules may employ as the remote computer 102A or 102B to control the operations of the local computer 104, or even the local computer 104 aforementioned in the embodiment.

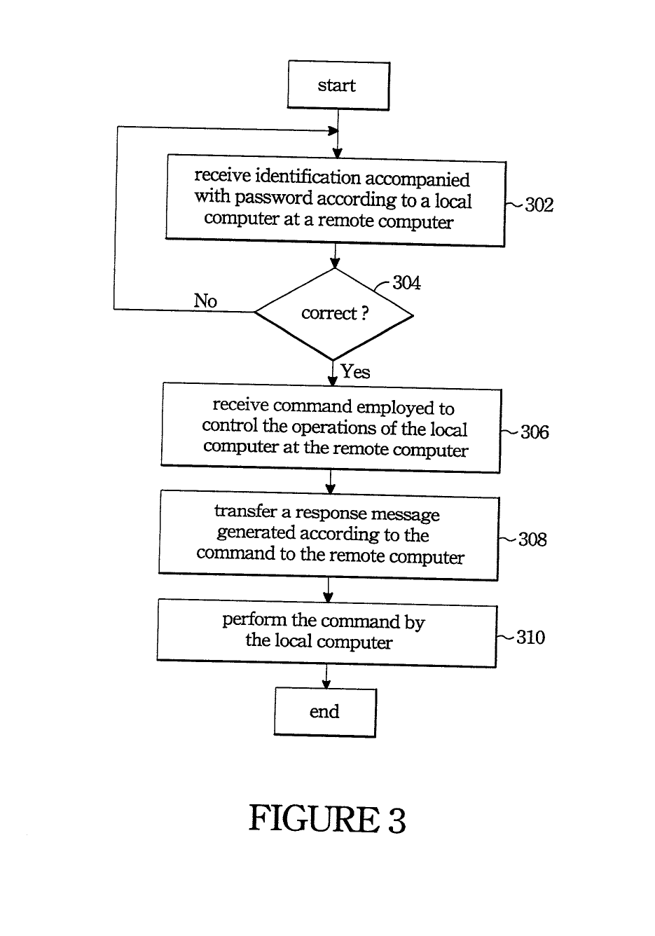

Please next refer to FIG. 3, a diagram illustrative the operating flow of the preferred embodiment is disclosed therein. When a user input his/her identification and password in the remote computer 102A or 102B in block 302, an authentication procedure will then be performed in block 304. The user may input commands in the remote computer 102A or 102B to control the operations of the local computer 104 if he/she is authenticated in block 306. The command will be forwarded to the local computer 104 via the communication link 106 and wait for performing. The local computer 104 will transfer a response message to notify the user in the remote side in block 308 before performing in block 310. As noted, an acknowledgement message input by the user at remote computer may be optionally employed. For example, a further message may show to the user for notifying that the local computer will be turned off. The local computer will turn off itself when the user gives the acknowledgement message from the remote computer 102A or 102B.

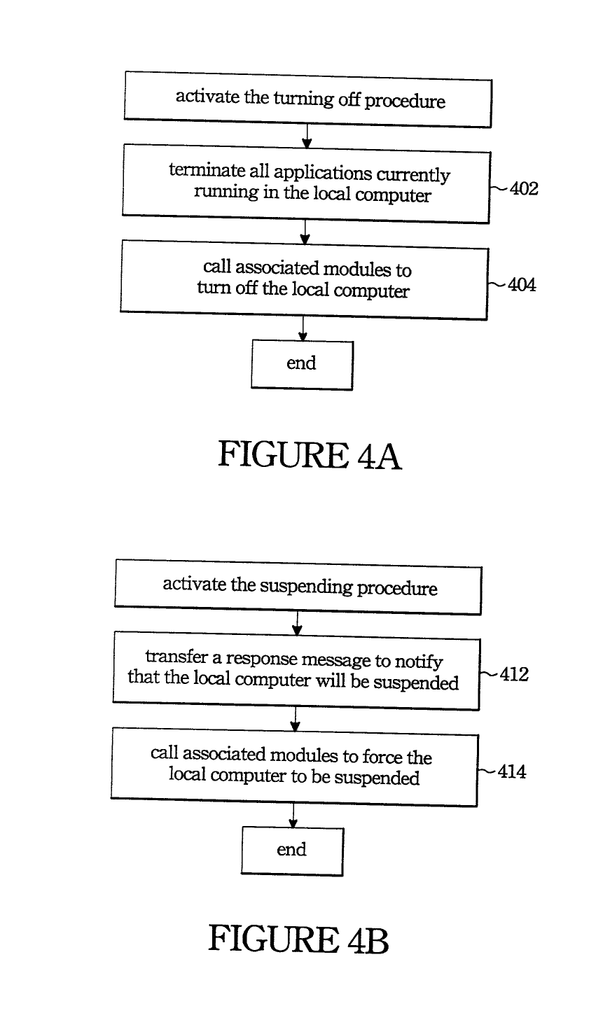

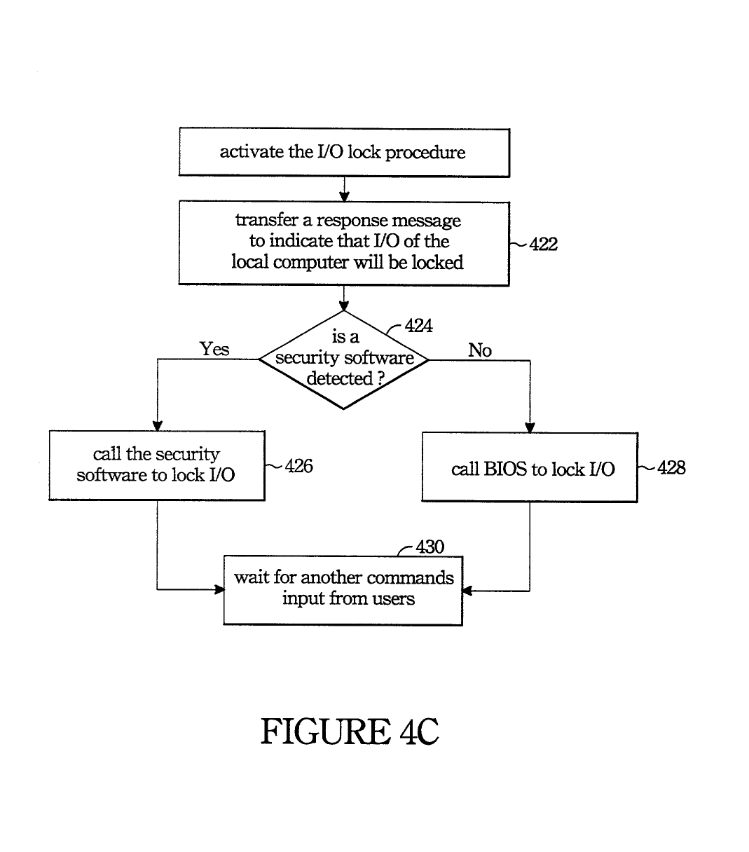

Please refer to FIGS. 4A, 4B, 4C, flow diagrams for illustrating the operations of turning off, suspending, and locking are respectively shown for giving further explanations. The command interpretation module 206 forces the operating system of the local computer to terminate all active applications after transferring associated response message to the remote computer in block 402 of FIG. 4. The power management module 1044 will then be activated to turn off the local computer in block 404. On the other hand, the command interpretation module 206 will call the power management module 1044 such as ACPI or APM to force the local computer 104 being suspended in block 414 of FIG. 4B after transferring associated response message to the remote computer in block 412. In the screen protection procedure of FIG. 4C, the command interpretation module 206 firstly detects whether additional security software mounted in the local computer is employed for achieving locking purpose in block 424 after associated response message being transferred to the remote computer in block 422. The input device 1048 of the local computer 104 will be locked if the security software is employed in block 426, otherwise the BIOS will be used to block commands input from mouse or keyboard of the local computer 104 in block 428. The input device 1048 is locked until correct identification accompanied with correct password are input and authenticated in block 430.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for securing information of a local computer from a remote computer, wherein said remote computer couples with said local computer via a communication link, said method comprising the steps of:
inputting a command at said remote computer for controlling operations of said local computer, wherein said command being employed to prevent an unauthenticated user from performing unallowable operations in said local computer;
transferring said command to said local computer via said communication link;
generating a response message by said local computer according to said command, wherein said response message is used to notify that the local computer is going to perform operations indicated by said command;
transferring said response message to said remote computer via said communication link; and
performing said operations indicated by said command in said local computer.

2. The method according to claim 1, further comprising an authenticating step comprising the steps of:
receiving an identification and a password associated with said identification; and
generating a response message for notifying said command being allowably input in said remote computer when said identification and said password are authenticated.

3. The method according to claim 1, wherein said command comprises a command used for turning off, suspending, or locking said local computer.

4. The method according to claim 3, wherein said turning off command or said suspending command is performed by employing an advanced power management (APM) module or an advanced configuration and power interface specification (ACPI) module.

5. The method according to claim 3, wherein said locking command is performed by a basic input output system (BIOS) or by employing a quick lock function provided by a security software mounted in said local computer.

6. A system for securing information of a local computer from a remote computer, wherein said remote computer couples with said local computer via a communication link, said system comprising:
a first remote command control module included in said remote computer for receiving a command that is used to control operations of said local computer, for transferring said command to said local computer via said communication link, and for receiving a response message from said local computer;
a second remote command control module included in said local computer for generating said response message according to said command, for transferring said response message to said remote computer via said communication link, and for performing operations indicated by said command; and
a power management module included in said local computer being responsive to said command for controlling power status of said local computer to secure information of said local computer.

7. The system according to claim 6, further comprising a locking module included in said local computer being responsive to said command for locking input devices of said local computer.

8. The system according to claim 7, wherein said locking module locks said input devices of said local computer by employing a basic input output system (BIOS) or by employing a quick lock function provided by a security software mounted in said local computer.

9. The system according to claim 6, wherein said power management module comprises an advanced power management (APM) module or an advanced configuration and power interface specification (ACPI) module.

10. The system according to claim 6, wherein said power management module control said power status by turning off or suspending said local computer.

11. The system according to claim 6, wherein said first remote command control module comprises:
a response message module for receiving said response message and displaying said response message; and
a command transference module for transferring said command to said local computer after packaging said command into a plurality of packets, and for unpacking a plurality of packets of said response message to restore said response message.

12. The system according to claim 6, wherein said second remote command control module comprises:
a command interpreting module for interpreting said command;
a response message module for generating said response message; and
a command transference module for transferring said response message to said remote computer after packaging said response message into a plurality of packets, and for unpacking a plurality of packets of said command to restore said command.

13. The system according to claim 12, wherein said response message is transferred to said remote computer before said local computer performs said operations indicated by said command.

14. A computer-readable media for storing programs of a method for securing information of a local computer from a remote computer, wherein said remote computer couples with said local computer via a communication link, said computer-readable media comprises:
a first remote command control module included in said remote computer for receiving a command that is used to control operations of said local computer, for transferring said command to said local computer via said communication link, and for receiving a response message from said local computer;
a second remote command control module included in said local computer for generating said response message according to said command, for transferring said response message to said remote computer via said communication link, and for performing operations indicated by said command; and
a power management module included in said local computer being responsive to said command for controlling power status of said local computer to secure information of said local computer.

15. The computer-readable media according to claim 14, further comprising a locking module included in said local computer being responsive to said command for locking input devices of said local computer.

16. The computer-readable media according to claim 15, wherein said locking module locks said input devices of said local computer by employing a basic input output system (BIOS) or by employing a quick lock function provided by a security software mounted in said local computer.

17. The computer-readable media according to claim 14, wherein said power management module comprises an advanced power management (APM) module or an advanced configuration and power interface specification (ACPI) module.

18. The computer-readable media according to claim 14, wherein said power management module control said power status by turning off or suspending said local computer.

19. The computer-readable media according to claim 14, wherein said first remote command control module comprises:
a response message module for receiving said response message and displaying said response message; and
a command transference module for transferring said command to said local computer after packaging said command into a plurality of packets, and for unpacking a plurality of packets of said response message to restore said response message.

20. The computer-readable media according to claim 14, wherein said second remote command control module comprises:
a command interpreting module for interpreting said command;
a response message module for generating said response message; and
a command transference module for transferring said response message to said remote computer after packaging said response message into a plurality of packets, and for unpacking a plurality of packets of said command to restore said command.
